(19) United States
(12) Patent Application Publication
(10) Pub. No.: US 2026/0113611 A1
(43) Pub. Date: Apr. 23, 2026

(54) MANAGING LOCATION REPORTING IN MISSION-CRITICAL SERVICE COMMUNICATION SYSTEM

(71) Applicant: Samsung Electronics Co., Ltd., Suwon-si (KR)

(72) Inventors: Arunprasath RAMAMOORTHY, Bangalore (IN); Jamsheed Manja PPALLAN, Bangalore (IN)

(21) Appl. No.: 19/363,180

(22) Filed: Oct. 20, 2025

Related U.S. Application Data
(63) Continuation of application No. PCT/KR2025/016369, filed on Oct. 16, 2025.

(30) Foreign Application Priority Data
Oct. 22, 2024 (IN) 202441080312
Sep. 11, 2025 (IN) 202441080312

(51) Int. Cl. H04W 4/90; H04W 4/029

(52) U.S. Cl. CPC H04W 4/90; H04W 4/029

(57) ABSTRACT

A method for managing location reporting in a mission-critical (MC) service communication system is provided. The method includes receiving, by a location management server, a location reporting trigger from a first location management client device, wherein the location reporting trigger requests to override at least one existing location reporting trigger of the second location management client device, checking, by the location management server, whether the first location management client device is authorized to override the existing location reporting trigger of the second location management client device based on the location reporting trigger, storing, by a location management server, a current location reporting configuration for the second location management client device at a local storage, and initiating, by the location management server, an event triggered location reporting procedure for the second location management client device.

### CROSS-REFERENCE TO RELATED APPLICATION(S)

This application is a continuation application, claiming priority under 35 U.S.C. § 365 (c), of an International application No. PCT/KR2025/016369, filed on Oct. 16, 2025, which is based on and claims the benefit of an Indian Provisional patent application number 202441080312, filed on Oct. 22, 2024, in the Indian Intellectual Property Office, and of an Indian Complete patent application number 202441080312, filed on Sep. 11, 2025, in the Indian Intellectual Property Office, the disclosure of each of which is incorporated by reference herein in its entirety.

### FIELD OF INVENTION

The disclosure relates to the field of location management for mission-critical (MC) services. More particularly, the disclosure relates to a system and method for managing location reporting within a mission-critical service communication system.

### BACKGROUND

MC Services, as standardized by the 3rd generation partnership project (3GPP), are designed to support high-reliability, security, and availability in communication systems tailored for public safety organizations and other industries that demand robust operational capabilities. One of the fundamental aspects of MC Services is location management, which plays a crucial role in providing precise and reliable location information essential for effective emergency coordination. Timely and accurate location updates are necessary to maintain situational awareness during emergency events. Further, secure handling of location information, including encryption and access control, is paramount to ensure data security. Interoperability across heterogeneous devices and networks is also highly desirable to enable seamless communication among different entities included in mission-critical operations.

Despite the advancements in MC Services, existing systems exhibit significant limitations in location management functionalities. There is no mechanism that allows an authorized MC service user to override location reporting triggers configured at a reporting MC service user. In certain mission-critical scenarios, it may be necessary for an authorized MC service user, such as an administrator or dispatcher, to override the location reporting triggers set at the reporting MC service user. When such an override is required, the location management client of the reporting MC service user's user equipment (UE) should be capable of reporting location information based on new location reporting triggers received in a location reporting trigger request including an override indicator originating from the location management client of the authorized requesting MC service user's UE. However, current systems lack an authorization mechanism to verify whether the requesting MC service user is permitted to perform such an override operation.

The 3GPP SA6 working group, responsible for developing stage specifications for mission-critical features, continuously enhances location management functionalities based on field experience, particularly from public safety agencies. For operational or technical reasons, such as reducing the signaling load in a cell, an authorized MC service user should be able to override the aggregated trigger configuration for one or more reporting location management clients. Existing systems do not provide a mechanism that enables an authorized requesting MC service user to override the location reporting triggers set at a reporting MC service user. In certain mission-critical scenarios, it may be necessary for an authorized MC service user, such as an administrator or dispatcher, to perform such an override. Furthermore, there is no mechanism for the cancellation of overridden location reporting triggers by the authorized requesting MC service user.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and authorized server/client device for managing location reporting in the mission critical (MC) service communication system.

Another aspect of the disclosure is to enable a location reporting override request by allowing the location management client of a requesting MC service user to indicate within the request to the location management server a new information element referred to as a location reporting trigger override indicator.

Another aspect of the disclosure is to provide an authorization mechanism where the location management server checks whether the requesting MC service user is authorized to override the location reporting trigger at the reporting MC service user by referring to the location user profile configuration data of the requesting MC service user.

Another aspect of the disclosure is to provide the authorization mechanism by introducing new entries into the location user profile configuration data of the MC service user in order to specify whether the MC service user is authorized to execute the location reporting trigger override and the location reporting trigger cancel override.

Another aspect of the disclosure is to provide a location reporting override cancel request. The location management client of the requesting MC service user requests cancellation of the override of the location reporting trigger set at the location management client of the reporting MC service user.

Another aspect of the disclosure is to provide for storing the current location reporting configuration where the location management server stores the location reporting triggers or location reporting configuration of the reporting MC service user that existed prior to the override request locally when the location reporting trigger override is requested by the authorized user.

Another aspect of the disclosure is to provide for restoring the stored location reporting configuration, the location management server restoring the locally stored location reporting configuration to the location management client once the location reporting trigger override is cancelled by the authorized MC service user.

Additional aspects will be set forth in part in the description which follows and, in part, will be apparent from the description, or may be learned by practice of the presented embodiments.

In accordance with an aspect of the disclosure, a method for managing location reporting in a MC service communication system is provided. The method includes receiving, by a location management server, a location reporting trigger from a first location management client device, wherein the location reporting trigger requests to override at least one existing location reporting trigger of a second location management client device, checking, by the location management server, whether the first location management client device is authorized to override the existing location reporting trigger of the second location management client device based on the location reporting trigger, storing, by the location management server, a current location reporting configuration for the second location management client device at a local storage, and initiating, by the location management server, an event triggered location reporting procedure for the second location management client.

In accordance with another aspect of the disclosure, a method for managing location reporting in the MC service communication system is provided. The method includes sending by an authorized location management client device a request message to a location management server to cancel a trigger override for a candidate location management client device, and initiating by the authorized location management client device a trigger override procedure for the target location management client device.

In accordance with another aspect of the disclosure, a location management server for managing location reporting in the MC service communication system is provided. The location management server includes memory, comprising one or more storage media, storing instructions, one or more processors communicatively coupled to the memory, and a location reporting controller, coupled to the memory and the one or more processors, wherein the instructions, when executed by the one or more processors individually or collectively, cause location management server to receive a location reporting trigger from a first location management client device, wherein the location reporting trigger requests to override an existing location reporting trigger of a second location management client device, check whether the first location management client device is authorized to override the existing location reporting trigger of the second location management client based on the location reporting trigger, store a current location reporting configuration for the second location management client device at a local storage, and initiate an event-triggered location reporting procedure for the second location management client device.

In accordance with another aspect of the disclosure, one or more non-transitory computer-readable storage media storing one or more computer programs including computer-executable instructions that, when executed by one or more processors of a location reporting controller individually or collectively, cause the location management server to perform operations are provided. The operations include receiving, by a location management server from a first location management client device, a first location reporting trigger requesting to override at least one existing location reporting trigger of a second location management client device, checking, by the location management server, whether the first location management client device is authorized to override the existing location reporting trigger of the second location management client; device based on the first location reporting trigger, storing, by the location management server, a current location reporting configuration for the second location management client device at a local storage, and initiating, by the location management server, a first event-triggered location reporting procedure for the second location management client device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is a block diagram that illustrates a location management server for both overriding and canceling location reporting triggers in a mission critical (MC) service communication system according to an embodiment of the disclosure;

FIG. 2 is a block diagram that illustrates an authorized location management client device for managing location reporting in a MC service communication system according to an embodiment of the disclosure;

FIG. 3 is a flowchart that illustrates a method for overriding a location reporting trigger for managing location reporting in a MC service communication system according to an embodiment of the disclosure;

FIG. 4 is a flowchart that illustrates a method for canceling a location reporting trigger override in the MC service communication system according to an embodiment of the disclosure;

FIG. 5 is a flowchart that illustrates a method performed by an authorized location management client device for managing location reporting in a MC service communication system according to an embodiment of the disclosure;

FIG. 6 is a sequence diagram that illustrates a procedure to override location reporting trigger according to an embodiment of the disclosure; and

FIG. 7 is a sequence diagram illustrating a procedure for canceling a location reporting trigger override in a MC service communication system according to an embodiment of the disclosure.

Throughout the drawings, it should be noted that like reference numbers are used to depict the same or similar elements, features, and structures.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings facilitate understanding of various technical features. The embodiments are not limited by these drawings and extend to any alterations, equivalents, and substitutes. Terms like first, second, etc., are used for distinction and do not limit the elements.

The proposed disclosure relates to a method and an authorized server/client device for managing location reporting in the mission critical (MC) service communication system. A location management client, which is part of the MC service client, reports location information to the location management server. The location management server provisions the location management client with location reporting configurations based on trigger requests received from requesting MC service clients.

For example, consider a case where users A, B, C, and D are included. User B may request geographical coordinates and 3rd generation partnership project (3GPP) location information (e.g., Cell identifier (ID), tracking area) of user A at an interval of every five minutes. User C may request 3GPP location information of user A every ten minutes and further every ten seconds if user A is in a call. User D may request geographical coordinates whenever user A moves by 100 meters. The location management server updates the location reporting configuration of user A with this information, and the location management client of user A starts reporting location information based on the configured triggers.

In existing systems, once such triggers are configured by requesting users, there is no mechanism to control, modify, or override the location reporting pattern of the reporting MC service user's client. For operational or technical reasons, such as reducing signaling load in a cell, an authorized MC service user should be able to override the aggregated trigger configuration for one or more reporting location management clients. In some mission-critical scenarios, it may be necessary for an authorized MC service user, such as an administrator or dispatcher, to perform such an override, particularly in the case of cell overload or during emergency conditions.

Location management functionality for mission-critical services is specified in 3GPP TS 23.280. In the information flows of clause 10.9.2 and procedures of clause 10.9.3, the term “requesting MC service user” refers to the MC service user which sends a request to subscribe to location information reports, to trigger a location information report, or to modify existing triggers of another MC service user. The term “requested MC service user” refers to the MC service user whose location information is requested or whose existing triggers are to be modified. The term “reporting MC service user” refers to the MC service user which provides location information based on on-demand requests or trigger criteria.

Currently, there is no mechanism for an authorized requesting MC service user to override the location reporting triggers set at a reporting MC service user. Once overridden, the reporting MC service user should report location information based on new triggers included in an override request from the authorized requesting MC service user. Similarly, when the override is cancelled by the authorized MC service user, the location management server should restore the prior location reporting configuration of the reporting MC service user.

Location reporting plays a significant role for first responders and mission-critical agencies in effectively addressing emergency scenarios. However, existing systems lack mechanisms to support secure override and cancellation of location reporting triggers by authorized MC service users, resulting in shortcomings during overload and emergency situations.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and may include circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

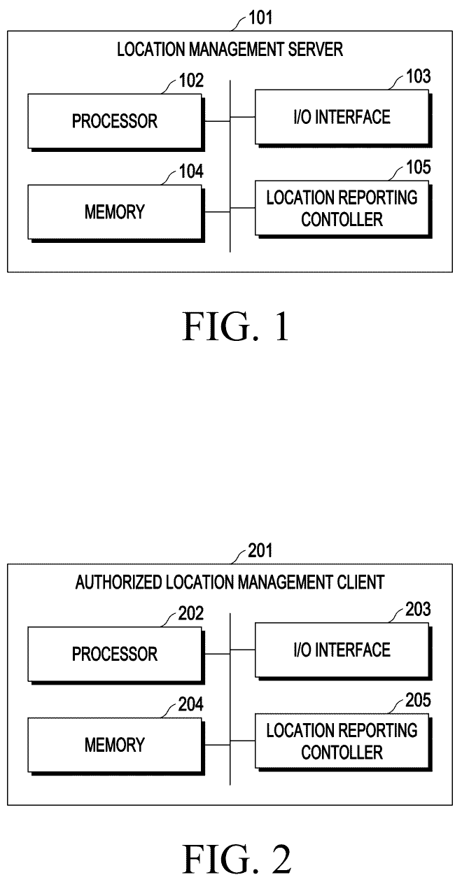

FIG. 1 illustrates a location management server for both overriding and canceling location reporting triggers in a mission critical (MC) service communication system according to an embodiment of the disclosure.

Referring to FIG. 1, the location management server (101) may include a processor (102), memory (104), an input/output (I/O) interface (103), and a location reporting controller (105).

The MC service communication system is a communication infrastructure designed to provide highly reliable, secure, and prioritized communication services for organizations and personnel whose operations are essential for public safety, national security, emergency response, and critical infrastructure management. These systems are characterized by stringent requirements for availability, reliability, low latency, interoperability, and the ability to maintain communication services during emergency situations or network congestion. In an embodiment, the MC service communication system may include a plurality of MC service clients and the location management server (101).

Examples of MC service communication systems include, but are not limited to, public safety communication networks (such as FirstNet (USA), emergency services network (ESN) (UK), terrestrial trunked radio (TETRA) networks, project 25 (P25) systems, digital mobile radio (DMR) networks, etc.), emergency response systems (such as 911/999/112 emergency call centers, fire department communication networks, police radio systems, ambulance service communication networks, emergency medical services (EMS) dispatch systems, etc.), transportation safety networks (such as railway emergency communication systems, aviation ground-to-air communication networks, maritime distress and safety systems, highway emergency response networks, public transit emergency communication, etc.), critical infrastructure communication (such as power grid supervisory control and data acquisition (SCADA) communication networks, nuclear plant safety systems, water treatment emergency networks, oil and gas pipeline communication systems, smart grid communication infrastructure, etc.), military and defense networks (such as tactical communication systems, command and control (C2) networks, military mobile radio systems, defense emergency communication networks, border security communication systems, etc.), healthcare emergency communication (such as hospital emergency communication networks, medical device monitoring systems, ambulance-to-hospital communication links, disaster medical response networks, telemedicine emergency systems, etc.), and industrial safety communication (such as mining safety communication networks, chemical plant emergency systems, manufacturing facility safety networks, construction site emergency communication, offshore platform communication systems, etc.).

In an embodiment, the location management server is a centralized network entity in the MC service communication system that manages, controls, and coordinates location reporting services for multiple client devices. It maintains location user profiles, processes location reporting triggers, verifies authorization for override operations, stores current location reporting configurations, and initiates location reporting configuration updates for client devices within the MC system.

Examples of the location management server may include a wide range of mission-critical and enterprise infrastructures. These may include public safety infrastructure servers such as emergency services command centers, dispatch centers, police command and control systems, and fire department communication centers; mission-critical communication platforms such as FirstNet infrastructure servers, TETRA network management systems, P25 core network servers, and professional mobile radio (PMR) control centers; and enterprise communication servers such as private long term evolution (LTE) core networks, industrial internet of things (IoT) management platforms, campus security control centers, and corporate emergency response systems. Further examples include transportation management systems such as railway traffic control centers, aviation ground control systems, maritime vessel traffic services, and highway emergency management centers; utility and infrastructure servers such as power grid control centers, water treatment facility management systems, oil and gas pipeline control centers, and smart city management platforms; healthcare communication systems such as hospital emergency response centers, ambulance dispatch systems, medical device management servers, and telemedicine coordination platforms; and military and defense systems such as tactical communication command centers, border security management systems, military base communication hubs, and defense network control centers.

In an embodiment, the location management client is a communication endpoint device in the MC service communication system that may send location reporting triggers, request trigger overrides for other client devices, initiate cancellation procedures, and communicate with the location management server for location-based services coordination and management.

Examples of the location management client device may include a variety of mission-critical, industrial, and enterprise-grade communication equipment. These devices may include public safety devices such as police radios, firefighter communication units, paramedic mobile devices, emergency responder tablets, and body-worn cameras with location services; first responder vehicles such as police cars with integrated communication systems, fire trucks with command units, ambulances with dispatch terminals, emergency response command vehicles, and mobile incident command centers; and professional mobile radios such as TETRA handsets, P25 portable radios, DMR digital radios, push-to-talk (PTT) devices, and rugged communication tablets. Other examples include transportation communication devices such as train conductor radios, aircraft ground crew communication units, ship bridge communication systems, bus driver dispatch units, and taxi fleet management devices; industrial and utility devices such as power plant worker radios, oil rig communication terminals, mining safety communication devices, water treatment facility control units, and smart grid field devices; and healthcare mobile devices such as hospital staff communication devices, ambulance crew tablets, medical equipment with location services, nurse call system terminals, and emergency medical technician (EMT) devices. Additional examples include security and surveillance systems such as security guard radios, patrol vehicle communication units, access control terminals, surveillance operator workstations, and campus security mobile devices, as well as enterprise communication devices such as facility manager mobile units, corporate emergency response tablets, warehouse management terminals, construction site communication devices, and event security communication systems.

In another embodiment, the processor (102) of the location management server (101) communicates with the memory (104), the I/O interface (103), and the location reporting controller (105). Configured to execute instructions stored in the memory (104), the processor (102) performs various processes. The processor (102) may include the location reporting controller (105). The processor (102) may include one or a plurality of processors, such as a general-purpose processor like a central processing unit (CPU), an application processor (AP), a graphics processing unit (GPU), a visual processing unit (VPU), and/or an artificial intelligence (AI) dedicated processor like a neural processing unit (NPU).

The memory (104) of the location management server (101) may include storage locations addressable through the processor (102). It is not limited to volatile memory and/or non-volatile memory and may include one or more computer-readable storage media. Non-volatile storage elements may include magnetic hard discs, optical discs, floppy discs, flash memories, or forms of electrically programmable read only memories (EPROMs) or electrically erasable and programmable ROM (EEPROM) memories.

The I/O interface (103) transmits information between the memory (104) and external peripheral devices. These peripheral devices are the input-output devices associated with the location management server (101). The I/O interface (103) receives several pieces of information from the location management server (101).

Coupled to the memory (104) and the processor (102), the location reporting controller (105) allows efficient data transfer and communication between components, ensuring real-time access and processing of location reporting trigger data. This innovative integrated circuit, implemented in the location management server (101), may include a multi-core architecture that enables dynamic management of location reporting triggers and override operations in the mission-critical service communication system. Each core is optimized for specific tasks such as authorization verification, trigger override processing, location configuration storage management, and event-triggered location reporting procedure initiation. In an embodiment, the innovative integrated circuit combines analog and digital components designed to optimize power consumption and performance. Analog components include a low-noise amplifier and a high-precision analog-to-digital converter for accurate signal processing of location reporting triggers. Digital components include a microcontroller unit (MCU) and a digital signal processor (DSP) that work in tandem to dynamically manage location reporting configuration updates and trigger override operations based on mission-critical service requirements.

The location reporting controller (105) receives the location reporting trigger from the first location management client device (201a). The first MC service user equipment (UE) may include a first location management client device (201a). The location reporting trigger requests to override the existing location reporting trigger of the second location management client device (201b). The second MC service UE may include a second location management client device. In an example, the location reporting controller (105) verifies whether the first location management client device (201a) is authorized to override the existing location reporting trigger of the second location management client device (201b) based on the location reporting trigger. It stores the current location reporting configuration for the second location management client device (201b) before performing the override and initiates location reporting configuration updates for the second location management client device (201b). The location reporting controller (105) controls the reporting of location information by the second location management client device based on the updated location reporting configuration.

The verification process may include checking the credentials and permissions associated with the first location management client device (201a) to ensure that it has the necessary authority to perform the override. Further, the location reporting controller (105) logs all override operations for auditing and accountability purposes.

The event-triggered location reporting procedure in the location reporting controller (105) applies the location reporting triggers requested by the first location management client device (201a) without aggregating other trigger request messages received from other location management client devices. This ensures that the location reporting configuration updates are applied immediately, without waiting for additional trigger requests. The location reporting controller (105) prioritizes the processing of event-triggered location reporting procedures to ensure that critical location information is reported promptly.

To authorize the override request, the location reporting controller (105) verifies entries of a location user profile associated with the target location management client device. For example, the location user profile may include detailed information about the client device, including its operational status, location reporting history, and authorization levels. The verification process may include cross-referencing this information with the override request to ensure that it is valid and permissible.

Newly initiated trigger request messages for the second location management client device are applied only to the stored current location reporting configuration until the trigger override is canceled. This ensures that the location reporting configuration remains consistent and accurate, preventing any conflicts or discrepancies that may arise from multiple trigger requests.

In another embodiment, the location management server (101) handles both the initiation and cancellation of location reporting trigger overrides for location management client devices within the MC service communication system. The server employs a robust workflow management system to track and manage the status of trigger overrides, ensuring that they are executed and canceled in a controlled and orderly manner. Further, the server provides real-time notifications to client devices regarding the status of their trigger override requests.

The location reporting controller (105) handles, for example, both the initiation and cancellation of location reporting trigger overrides for location management client devices within the MC service communication system. It employs advanced algorithms to determine the optimal timing and conditions for initiating and canceling trigger overrides, ensuring that location reporting configurations are updated efficiently and accurately. The controller also features a user-friendly interface that allows authorized personnel to manage trigger overrides with ease.

Upon receiving a request message from the authorized location management client device to cancel the trigger override for the candidate location management client device, the location reporting controller (105) verifies whether the authorized location management client device is permitted to override existing location reporting triggers of the target location management client device. The verification process may include checking the credentials and permissions associated with the authorized location management client device to ensure that it has the necessary authority to perform the cancellation. Further, the location reporting controller (105) logs all cancellation operations for auditing and accountability purposes.

In an embodiment, the location reporting controller (105) retrieves the location reporting configuration for the target location management client device from local storage and initiates the event-triggered location reporting procedure for the target location management client device. This procedure restores the locally stored location reporting configuration. The controller ensures that the restored configuration is applied immediately, without waiting for additional trigger requests, to maintain the accuracy and consistency of location reporting.

The authorized location management client device and the candidate location management client device, along with the location reporting controller (105), are part of a single MC system. This integrated system architecture ensures, for example, seamless communication and coordination between the server and client devices, enabling efficient management of location reporting triggers and overrides. The system also features advanced security mechanisms to protect against unauthorized access and tampering.

The location reporting configuration for the target location management client device may include triggers stored locally at the location management server (101). These triggers are based on the operational requirements and priorities of the MC service communication system, ensuring that location reporting is optimized for mission-critical operations. The server periodically updates these triggers based on real-time data and predictive analytics to ensure that they remain relevant and effective.

A subscribed location management client device in the location reporting controller (105) has subscribed to the candidate location management client device and applied location reporting triggers to the target location management client device prior to the cancellation request message. In an embodiment, the subscription process may include registering the client device with the server and configuring it to receive location reporting triggers based on criteria. The server manages the subscription status and ensures that location reporting triggers are applied consistently and accurately.

The verification performed by the location reporting controller (105) may include authorizing a cancel override request based on entries in a location user profile associated with the target location management client device. The location user profile may include detailed information about the client device, including its operational status, location reporting history, and authorization levels. The verification process may include cross-referencing this information with the cancel override request to ensure that it is valid and permissible. The controller also logs all verification operations for auditing and accountability purposes.

FIG. 2 is a block diagram illustrating an authorized location management client device for managing location reporting in a MC service communication system according to an embodiment of the disclosure.

Referring to FIG. 2, a location management client device (201) serves as a communication endpoint in the MC service communication system, participating in location reporting services. It may send and receive location reporting triggers, request trigger overrides for other client devices, initiate cancellation procedures, and communicate with the location management server (101) for coordinated location-based services within the MC system infrastructure.

Examples of location management client devices (201) include, but are not limited to, public safety mobile devices (such as police handheld radios, firefighter portable communication units, paramedic emergency response tablets, emergency responder body-worn devices, search and rescue communication equipment, etc.), first responder vehicle systems (such as police patrol car communication terminals, fire engine mobile command units, ambulance dispatch and navigation systems, emergency response vehicle tracking devices, mobile incident command centers, etc.), professional mobile radio equipment (such as TETRA portable handsets, P25 digital radio units, DMR mobile radios, push-to-talk over cellular (PoC) devices, rugged tactical communication tablets, etc.), transportation communication devices (such as train conductor mobile radios, aircraft ground crew communication units, maritime vessel bridge communication systems, bus driver dispatch terminals, commercial vehicle fleet management devices, etc.), industrial and utility field devices (such as power grid maintenance worker radios, oil and gas field communication terminals, mining safety communication devices, water treatment plant mobile units, smart grid field service equipment, etc.), healthcare mobile communication systems (such as hospital staff secure communication devices, ambulance crew medical tablets, medical equipment location tracking units, emergency medical technician (EMT) portable devices, healthcare facility security communication equipment, etc.), and security and surveillance equipment (such as security guard patrol radios, campus safety mobile communication units, event security coordination devices, border patrol communication equipment, critical infrastructure security mobile terminals, etc.).

The processor (202) of the location management client device (201) communicates with the memory (204), the I/O interface (203), and the location reporting controller (205). Configured to execute instructions stored in the memory (204), the processor (202) performs various processes. The processor (202) may include the location reporting controller (205). The processor (202) may include one or a plurality of processors, such as a central processing unit (CPU), an application processor (AP), a graphics processing unit (GPU), a visual processing unit (VPU), and/or an artificial intelligence (AI) dedicated processor like a neural processing unit (NPU).

Further, the memory (204) of the location management client device (201) may include storage locations addressable through the processor (202). The memory (204) is not limited to volatile memory and/or non-volatile memory and may include one or more computer-readable storage media. Non-volatile storage elements, for example, may include magnetic hard discs, optical discs, floppy discs, flash memories, or forms of EPROM or EEPROM memories.

The I/O interface (203) transmits information between the memory (204) and external peripheral devices. These peripheral devices are the input-output devices associated with the location management server (205). The I/O interface (203) receives several pieces of information from the location management client device (201).

Coupled to the memory (204) and the processor (202), the location reporting controller (205) allows for efficient data transfer and communication between components, ensuring real-time access and processing of cancel override request message data. This innovative integrated circuit, implemented in the authorized location management client device (201), may include a multi-core architecture that enables dynamic management of trigger override procedure initiation and cancellation request generation in the mission-critical service communication system. In an example, each core is optimized for specific tasks such as request message generation, trigger override procedure initiation, server communication management, and candidate device targeting operations. The innovative integrated circuit for managing location reporting trigger override requests in the mission-critical service communication system is composed of a combination of analog and digital components designed to optimize power consumption and performance of the client-side override request mechanism. Analog components include a low-noise amplifier and a high-precision analog-to-digital converter to ensure accurate signal processing of server communications. Digital components include a microcontroller unit (MCU) and a digital signal processor (DSP) that work in tandem to dynamically manage the trigger override procedure initiation and cancellation request transmission based on mission-critical service requirements.

Furthermore, the structure of the innovative integrated circuit may include a multi-core architecture that enables dynamic management of trigger override cancellation and configuration restoration operations in the mission-critical service communication system. Each core is optimized for specific tasks such as cancel request authorization verification, trigger override cancellation processing, locally stored configuration restoration management, and event-triggered location reporting procedure initiation. The innovative integrated circuit for managing location reporting trigger override cancellation in the mission-critical service communication system is composed, for example, of a combination of analog and digital components designed to optimize power consumption and performance of the override cancellation mechanism. Analog components include a low-noise amplifier and a high-precision analog-to-digital converter to ensure accurate signal processing of cancel override requests. Digital components include a microcontroller unit (MCU) and a digital signal processor (DSP) that work in tandem to dynamically manage configuration restoration and trigger override cancellation operations based on mission-critical service requirements.

The location reporting controller (205) in the authorized location management client device (201) sends the request message to the location management server to cancel the trigger override for the target location management client device. Prior to requesting the cancellation, the location reporting controller (205) in the authorized location management client device (201) initiates the trigger override procedure for the target location management client device.

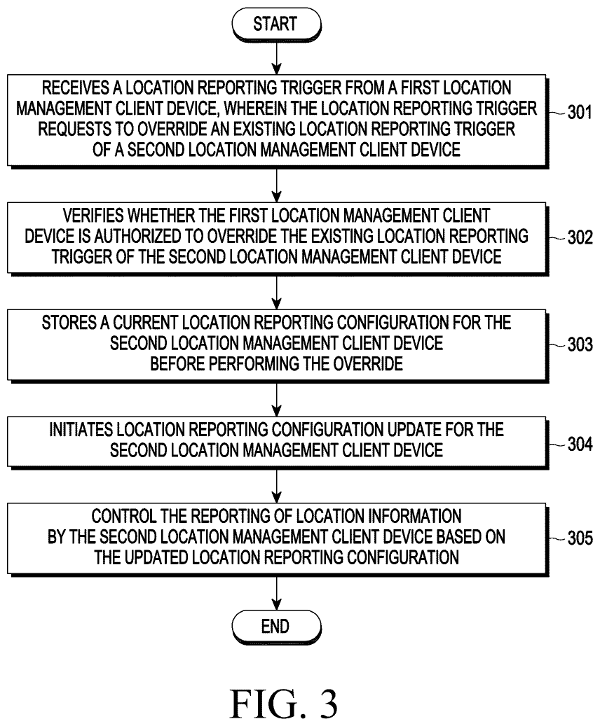

FIG. 3 is a flowchart that illustrates a method for overriding a location reporting trigger for managing location reporting in a MC service communication system, according to an embodiment of the disclosure.

Referring to FIG. 3, at operation 301, the method may include receiving the location reporting trigger from the first location management client device (201a) by a location management server (101), The location reporting trigger requests to override the existing location reporting trigger of the second location management client device (201b).

At operation 302, the method may include verifying whether the first location management client device (201a) is authorized to override the existing location reporting trigger of the second location management client device (201b) by the location management server (101) based on the location reporting trigger.

At operation 303, the method may include storing the current location reporting configuration for the second location management client device (201b) by the location management server (101). This operation ensures that the original configuration may be restored if needed. The stored configuration may include details such as the original reporting intervals, the types of location data being reported, and any specific conditions under which the reporting was previously triggered.

At operation 304, the method may include initiating a location reporting configuration update for the second location management client device (201b) by the location management server (101). This may include sending a configuration update message to the second client device, instructing it to adjust its location reporting behavior according to the new parameters. The update process may also include a confirmation operation to ensure that the second client device has successfully received and applied the new configuration.

At operation 305, the method may include controlling the reporting of location information by the second location management client device based on the updated location reporting configuration by the location management server. The server continuously monitors the location reports from the second client device to ensure compliance with the updated configuration. If any discrepancies are detected, the server may take corrective actions, such as re-sending the configuration update or alerting an operator.

In an embodiment, the location reporting trigger from the first location management client device (201a) is provided to reduce signaling load in a cell by suppressing or modifying reporting triggers of the second location management client device (201b) not participating in an emergency response. This helps to optimize network resources by reducing unnecessary location updates from devices that are not critical to the current operation. The suppression mechanism may be dynamically adjusted based on real-time network conditions and operational priorities.

In another embodiment, the location reporting trigger from the first location management client device (201a) is provided to enable increased frequency of location reporting by the second location management client device (201b) in an emergency scenario. This ensures that the location of critical devices is updated more frequently, providing real-time situational awareness to the operators. The increased reporting frequency may be crucial for coordinating emergency response efforts and ensuring the safety of personnel.

In yet another embodiment, the location reporting trigger from the first location management client device (201a) is provided to disable or reduce location reporting from the second location management client device (201b) when it is stolen or compromised. This helps to prevent unauthorized access to sensitive location data and reduces the risk of the compromised device being used to mislead or disrupt operations. The server may also initiate additional security measures, such as locking the device or alerting security personnel.

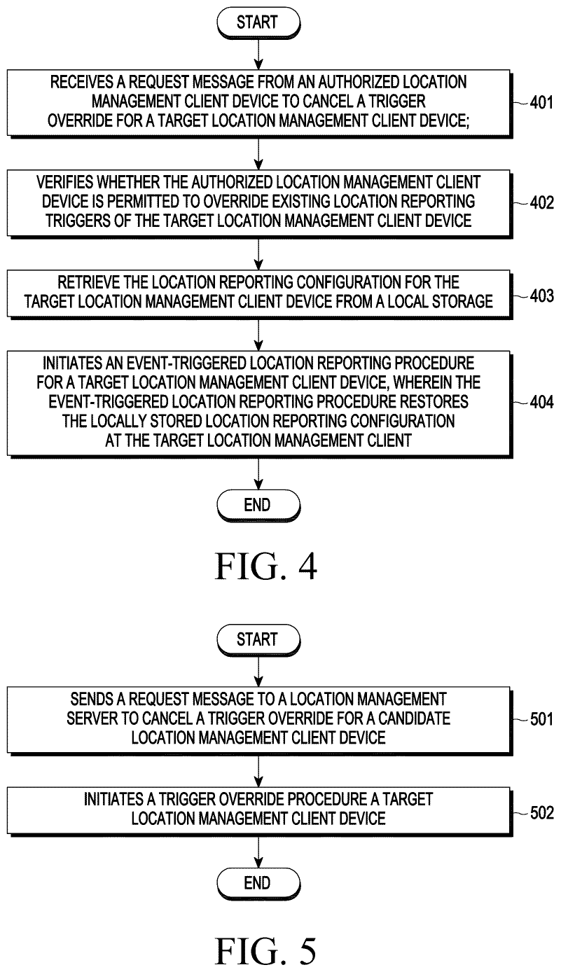

FIG. 4 is a flowchart that illustrates a method for canceling a location reporting trigger override in a MC service communication system, according to an embodiment of the disclosure.

Referring to FIG. 4, at operation 401, the method may include receiving the request message from the authorized location management client device (201) to cancel the trigger override for the target location management client device at the location management server (101).

At operation 402, the method may include verifying whether the authorized location management client device (201) is authorized to override existing location reporting triggers of the target location management client device by the location management server (101).

At operation 403, the method may include retrieving the location reporting configuration for the target location management client device from the local storage by the location management server. This operation ensures that the original configuration is available for restoration. The server may also check the integrity of the stored configuration to ensure that it has not been tampered with or corrupted.

At operation 404, the method may include initiating the event-triggered location reporting procedure for the target location management client device by the location management server (101). The event-triggered location reporting procedure restores the locally stored location reporting configuration. This may include sending a configuration update message to the target device, instructing it to revert to the original reporting parameters. The server may also monitor the target device to confirm that the original configuration has been successfully restored.

FIG. 5 is a flowchart that illustrates a method performed by an authorized location management client device for managing location reporting in a MC service communication system, according to an embodiment of the disclosure.

Referring to FIG. 5, at operation 501, sending the request message to the location management server (101) to cancel the trigger override for the candidate location management client device by the authorized location management client device (201).

At operation 502, initiating the trigger override procedure for the target location management client device by the authorized location management client device (201).

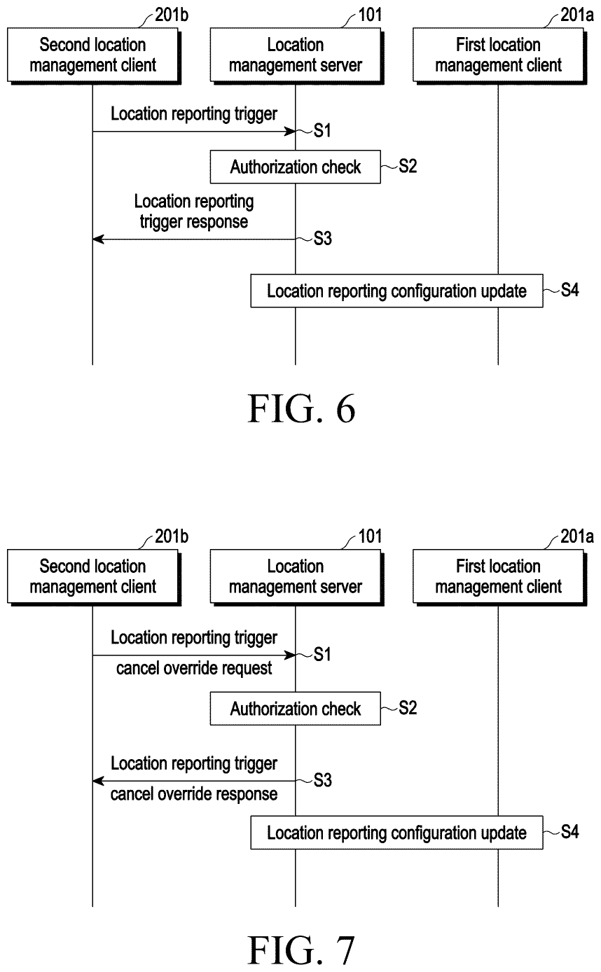

FIG. 6 is a sequence diagram illustrating a procedure to override location reporting triggers according to an embodiment of the disclosure.

In an embodiment, the override procedure is initiated after the pre-condition that the location management client device has been provisioned with location reporting configuration information.

Referring to FIG. 6, at operation S1, the second location management client device (201b), acting as an authorized MC service user, transmits the location reporting trigger to the location management server (101) to activate the location reporting procedure for obtaining location information of the first location management client device (201a). When the second location management client device (201b) intends to override the existing location reporting triggers of the first location management client device (201a), it sets a location reporting trigger override indicator accordingly.

At operation S2, the location management server (101) verifies whether the second location management client device (201b) is authorized to transmit the location reporting trigger for obtaining the location information of the first location management client device (201a). When the location reporting trigger override indicator is set, the location management server (101) further determines whether the second location management client device (201b) is authorized to override the location reporting triggers of the first location management client device (201a). Upon successful authorization, the location management server (101) proceeds to the next operations.

At operations S3 and S4, based on the information specified in the location reporting trigger, the location management server (101) initiates either an on-demand location reporting procedure or an event-triggered location reporting procedure for obtaining the location of the first location management client device (201a). When the location reporting trigger override indicator is set, the location management server (101) stores the existing location reporting triggers of the first location management client device (201a) and updates the location reporting triggers to include the triggers and information received in operation S1.

FIG. 7 is a sequence diagram illustrating a procedure for cancelling a location reporting trigger override in a MC service communication system according to an embodiment of the disclosure.

In an embodiment, a procedure for cancelling the location reporting trigger override is performed subject to certain pre-conditions. Specifically, the location reporting configuration of the first location management client device (201a) has been previously overridden by the second location management client device (201b). Further, the location management server (101) has locally stored the location reporting configuration information of the first location management client device (201a) that existed prior to the override performed by the second location management client device (201b), which is an authorized requesting MC service user.

Referring to FIG. 7, at operation S1, the second location management client device (201b), which is an authorized MC service user, transmits the location reporting trigger cancel override request to the location management server (101) for cancelling the override of the location reporting triggers at the first location management client device (201a). The request may include the MC service identifier of the requesting MC service user and the MC service identifier of the reporting MC service user.

At operation S2, the location management server (101) verifies whether the second location management client device (201b) is authorized to cancel the override of the location reporting triggers at the first location management client device (201a). Upon successful authorization, the location management server (101) proceeds to the next operations.

At operation S3, the location management server (101) transmits the location reporting trigger cancel override response indicating the status of the request, specifying whether the request has succeeded or failed. At operation S4, upon successful authorization, the location management server (101) updates the location reporting triggers or configuration at the location management client (201a) with the location reporting configuration information previously stored locally by the location management server (101).

Format as in Table 1 can be followed if the MC system wants to specify the list of users for whom the requesting MC service user is authorized to override/cancel override the location reporting triggers.

TABLE 1

| | | | | Configuration | Location |
|---|---|---|---|---|---|
| | Parameter | | Location | management | user |
| Reference | description | Location UE | Server | server | database |
| | Authorization to | | | | |
| | override the location | | | | |
| | reporting | | | | |
| | triggers/location | | | | |
| | reporting | | | | |
| | configuration at a | | | | |
| | LMC | | | | |
| | > List of MC service | Y | Y | Y | Y |
| | IDs for which a | | | | |
| | trigger override is | | | | |
| | authorized | | | | |
| | >> MCPTT ID | Y | Y | Y | Y |
| | (see NOTE 1) | | | | |
| | >> MCVideo ID | Y | Y | Y | Y |
| | (see NOTE 1) | | | | |
| | >> MCData ID | Y | Y | Y | Y |
| | (see NOTE 1) | | | | |
| | Authorization to | | | | |
| | cancel the override | | | | |
| | of the location | | | | |
| | reporting | | | | |
| | triggers/location | | | | |
| | reporting | | | | |
| | configuration at a | | | | |
| | LMC | | | | |
| | > List of MC service | Y | Y | Y | Y |
| | IDs for which a | | | | |
| | cancel override of | | | | |
| | the location | | | | |
| | reporting trigger | | | | |
| | trigger is authorized | | | | |
| | >> MCPTT ID | Y | Y | Y | Y |
| | (see NOTE 1) | | | | |
| | >> MCVideo ID | Y | Y | Y | Y |
| | (see NOTE 1) | | | | |
| | >> MCData ID | Y | Y | Y | Y |
| | (see NOTE 1) | | | | |

(NOTE 1):
There can be zero or more.

In an embodiment, the method for overriding location reporting triggers in a MC communication system is disclosed. The location reporting controller (105) of the location management server (101) receives a location reporting trigger override request from an authorized MC service client. In another embodiment, the location reporting controller (105) verifies whether the requesting MC service client is authorized to override one or more location reporting triggers configured for a target MC service client. In response to successful authorization, the location reporting controller (105) sets a location reporting trigger override indicator for the target MC service client, updates location reporting configuration information of the target MC service client based on the override request, and controls reporting of location information by the target MC service client to the location management server (101) in accordance with the updated location reporting configuration.

The authorized MC service client (also referred to as the authorized location management client) may include at least one dispatcher terminal or an administrator terminal. The override request is provided to reduce signaling load in the cell by suppressing or modifying reporting triggers of the MC service clients not participating in an emergency response. Further, the override request is provided to enable increased frequency of location reporting by a target MC service client in an emergency scenario. Furthermore, the override request is provided to disable or reduce location reporting from a stolen or compromised MC service UE.

In an embodiment, the authorized location management server (201) may store the updated location reporting configuration for future reporting sessions of the target MC service client. The proposed disclosure may receive the location reporting trigger cancel override request from an authorized MC service client. The location management server may verify whether the requesting MC service client is authorized to cancel the override. Upon successful verification, the location management server may update the location reporting configuration of a target MC service client to restore a previously stored configuration that existed prior to the override.

In an embodiment, the MC service clients report their location information based on a consolidated location reporting configuration received from the location management server. For example, if a first requesting client requires location information every five minutes and a second requesting client requires location information every ten seconds, the target MC service client reports the location every ten seconds. Under normal conditions, such reporting operates without issues. However, in an emergency scenario within a particular area, multiple responders are typically present, resulting in increased load on the serving cell. In such situations, MC service clients not actively participating in the emergency rescue may continue transmitting location reports, thereby consuming network resources. In this case, overriding location reporting triggers is advantageous to the dispatcher, who may override the location reporting triggers of clients not engaged in the emergency rescue operation. Absent this procedure, the alternative to reduce location reports is to instruct the requesting clients to stop triggering the location reporting requests, which is impractical and requires manual intervention.

In another embodiment, the override procedure is beneficial in scenarios involving a stolen MC service user equipment (UE) or an MC service UE belonging to police personnel held hostage. In such cases, the dispatch system may perform ambient listening of the MC service UE to monitor the surroundings and plan for the rescue operation. Frequent publishing of location reports from these devices leads to rapid battery drain. Accordingly, overriding the location reporting trigger functionality becomes advantageous. With this override procedure, authorized personnel such as a dispatcher or an administrator may control the location reporting of the MC service clients.

In yet another embodiment, a system and method for overriding the location reporting triggers configured at the location management client and cancellation of override by the authorized MC service user (via Location management client) is disclosed. The disclosure pertains to providing support for overriding the location reporting triggers set at the requested MC service user by an authorized requesting MC service user. Once the location reporting trigger is overridden by the authorized requesting MC service user, the location reporting triggers set at the requested MC service user are updated to include the location reporting triggers received as part of the location reporting trigger request with the override indicator. The location management client residing at the requested MC service user's user equipment thereafter reports its location information to the location management server based on the updated location reporting triggers.

The disclosure discloses the main functionality to achieve the overriding and cancellation of location reporting triggers, which includes overriding the location reporting triggers set at the reporting MC service user by an authorized requesting MC service user, the cancellation of the overridden location reporting triggers by the authorized requesting MC service user, storage at the location management server (101) of the location reporting triggers previously present at the reporting MC service user, rollback of the location reporting triggers to the previously stored values upon receipt of the location reporting trigger cancel override request from the authorized requesting MC service user, and implementation of authorization mechanisms to verify whether the requesting MC service user is authorized to override the location reporting triggers.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for managing location reporting in a mission-critical (MC) service communication system, the method comprising:
receiving, by a location management server from a first location management client device, a first location reporting trigger requesting to override at least one existing location reporting trigger of a second location management client device;
checking, by the location management server, whether the first location management client device is authorized to override the existing location reporting trigger of the second location management client device based on the first location reporting trigger;
storing, by the location management server, a current location reporting configuration for the second location management client device at a local storage; and
initiating, by the location management server, a first event-triggered location reporting procedure for the second location management client device.

2. The method as claimed in claim 1, wherein the first event-triggered location reporting procedure applies the first location reporting trigger requested by the first location management client device without aggregating other trigger request message received from other location management client device.

3. The method according to claim 1, wherein the checking, by the location management server, whether the first location management client device is authorized to override the existing location reporting trigger of the second location management client device is based on entries of a location user profile associated with a candidate location management client device.

4. The method as claimed in claim 1, further comprising:
applying, by the location management server, any newly initiated trigger request messages for the second location management client only to the stored current location reporting configuration until a trigger override for the second location management client device is cancelled.

5. The method as claimed in claim 1, wherein a list of MC service identifications for which a trigger override for the second location management client device is authorized comprise mission critical push to talk (MCPTT) identification (ID), MCVideo ID, and MCData ID.

6. The method as claimed in claim 1, further comprising:
receiving, by the location management server from the first location management client device, a second location reporting trigger requesting to cancel the trigger override for the second location management client device;
checking, by the location management server, whether the first location management client device is authorized to override at least one existing location reporting trigger of the second location management client device;
retrieving, by the location management server, the location reporting configuration for the second location management client device from the local storage;
initiating, by the location management server, a second event-triggered location reporting procedure for the second location management client device; and
restoring, by the location management server, the retrieved location reporting configuration.

7. The method as claimed in claim 6, wherein the location reporting configuration for the second location management client device includes location reporting configuration stored locally at the location management server.

8. The method according to claim 6, wherein the checking, by the location management server, whether the first location management client device is authorized to override at least one existing location reporting trigger of the second location management client device is based on entries of a location user profile associated with the second location management client device.

9. The method as claimed in claim 6, wherein a list of MC service identifications for which a cancel of the trigger override for the second location management client device is authorized comprise mission critical push to talk (MCPTT) identification (ID), MCVideo ID, and MCData ID.

10. A location management server for managing location reporting in a mission-critical (MC) service communication system, the location management server comprising:
memory, comprising one or more storage media, storing instructions; and
one or more processors communicatively coupled to the memory,
wherein the instructions, when executed by the one or more processors individually or collectively, cause the location management server to:
receive, from a first location management client device, a first location reporting trigger requesting to override at least one existing location reporting trigger of a second location management client device,
check whether the first location management client device is authorized to override the existing location reporting trigger of the second location management client based on the first location reporting trigger,
store a current location reporting configuration for the second location management client device before performing the override at a local storage, and
initiate a first event-triggered location reporting procedure for the second location management client device.

11. The location management server of claim 10, wherein the first event-triggered location reporting procedure applies the first location reporting trigger requested by the first location management client device without aggregating other trigger request message received from other location management client device.

12. The location management server of claim 10, wherein the check whether the first location management client device is authorized to override the existing location reporting trigger of the second location management client device is based on entries of a location user profile associated with a candidate location management client device.

13. The location management server of claim 10, wherein the instructions, when executed by the one or more processors individually or collectively, cause the location management server to apply any newly initiated trigger request messages for the second location management client only to the stored current location reporting configuration until a trigger override for the second location management client device is cancelled.

14. The location management server of claim 10, wherein a list of MC service identifications for which a trigger override for the second location management client device is authorized comprise mission critical push to talk (MCPTT) identification (ID), MCVideo ID, and MCData ID.

15. The location management server of claim 10, wherein the instructions, when executed by the one or more processors individually or collectively, cause the location management server to:
receive, from the first location management client device, a second location reporting trigger requesting to cancel the trigger override for the second location management client device,
check whether the first location management client device is authorized to override at least one existing location reporting trigger of the second location management client device,
retrieve the location reporting configuration for the second location management client device from the local storage,
initiate a second event-triggered location reporting procedure for the second location management client device, and
restore the retrieved location reporting configuration.

16. The location management server of claim 15, wherein the location reporting configuration for the second location management client device includes location reporting configuration stored locally at the location management server.

17. The location management server of claim 15, wherein the checking whether the first location management client device is authorized to override at least one existing location reporting trigger of the second location management client device is based on entries of a location user profile associated with the second location management client device.

18. The location management server of claim 15, wherein a list of MC service identifications for which a cancel of the trigger override for the second location management client device is authorized comprise mission critical push to talk (MCPTT) identification (ID), MCVideo ID, and MCData ID.

19. One or more non-transitory computer-readable storage media storing one or more computer programs including computer-executable instructions that, when executed by one or more processors of a location management server individually or collectively, cause the location management server to perform operations, the operations comprising:
receiving, by a location management server from a first location management client device, a first location reporting trigger requesting to override at least one existing location reporting trigger of a second location management client device;
checking, by the location management server, whether the first location management client device is authorized to override the existing location reporting trigger of the second location management client; device based on the first location reporting trigger;
storing, by the location management server, a current location reporting configuration for the second location management client device at a local storage; and
initiating, by the location management server, a first event-triggered location reporting procedure for the second location management client device.

20. The one or more non-transitory computer-readable storage media of claim 19, wherein the first event-triggered location reporting procedure applies the first location reporting trigger requested by the first location management client device without aggregating other trigger request message received from other location management client device.
